(19) United States
(12) Patent Application Publication
(10) Pub. No.: US 2026/0085769 A1
(43) Pub. Date: Mar. 26, 2026

(54) SEALING DEVICE FOR A VALVE

(71) Applicant: Anthony Steven FROEHLER, Calgary (CA)

(72) Inventors: Anthony Steven FROEHLER, Calgary (CA); Jordan Nelson Hicks, Calgary (CA)

(21) Appl. No.: 19/338,078

(22) Filed: Sep. 24, 2025

Related U.S. Application Data
(60) Provisional application No. 63/698,962, filed on Sep. 25, 2024.

(51) Int. Cl. F16K 41/04

(52) U.S. Cl. CPC F16K 41/04

(57) ABSTRACT

A sealing device for a valve is configured to be received in a packing chamber of the valve and to matably receive a stem of the valve therethrough that moves a valve member for selectively permitting flow of fluid through the valve body between a pair of ports thereof. The sealing device features a tubular body made of wearable and substantially deformation-resistant composite polymer material and a passageway through the tubular body, which is shaped with opposite end portions of reduced diameter to form a sealing friction fit with the stem.

This application claims the benefit under 35 U.S.C. 119(e) of U.S. provisional application Ser. No. 63/698,962 filed Sep. 25, 2024.

### TECHNICAL FIELD

The present invention relates generally to a fluid retention device for a valve, and more particularly to a sealing device configured to carry a biasing device for applying radial pressure on a body of the sealing device as to form a seal around a valve stem.

### BACKGROUND

Conventionally, a series of packing rings in the form of elastomeric gaskets, and of chevron-shaped cross-section, act to form a seal around a stem in a valve. (These packing rings are conventionally referred to in industry as V-rings.) Pressure of the seal around the stem can be varied by adjusting compression of the stacked series of chevron rings. As the stem moves, such as in reciprocating linear or rotary motion relative to its own axis, the packing rings wear. Therefore, in order to maintain consistent sealing performance, so as to prevent leaks out of a body of the valve, an axial compression of the stacked series of packing rings is adjusted, specifically increased. As such, it is desirable to continuously monitor the valve, and in particular a bonnet thereof through which the stem passes before extending into the passageway of the valve, and to adjust compression of the packing rings over time.

Furthermore, elastomers, that is the constituent material of the packing rings, are generally suited for one or a small range of chemicals that are regulated by the valve upon flowing therethrough. Therefore, when the same valve is switched from receiving a first type of chemical to a different type of chemical, the packing rings are replaced so as to provide sealing action on the stem against a specific type of chemical to flow through the valve. Furthermore, elastomers are susceptible to mechanical damage created by fine solids in the fluid passing through the valve.

### SUMMARY

According to an aspect of the disclosure, there is provided a sealing device for a valve, wherein the valve has:
a valve body configured to fluidically interconnect a first fluidic conduit for conveying a fluid and a second fluidic conduit for selectively receiving the fluid, wherein the valve body includes an inlet port configured for fluidic communication with the first fluidic conduit and an outlet port configured for fluidic communication with the second fluidic conduit;
wherein the valve body further includes a first chamber in fluidic communication with the inlet port, a second chamber in fluidic communication with the outlet port, and a valve seat intercommunicating the first and second chambers to form a passageway for the fluid to flow from the inlet port to the outlet port;
a valve member supported inside the valve body at or adjacent the valve seat and arranged to selectively obstruct fluidic intercommunication between the first and second chambers, wherein the valve member is movable relative to the valve seat between an open position in which the fluid is permitted to flow from the first chamber to the second chamber and a closed position in which the fluid is resisted from flowing from the first chamber to the second chamber;
a stem connected to the valve member and extending therefrom along an axis, wherein the stem is substantially cylindrical and has an outer surface having a diameter transverse to the axis;
an actuator operatively connected to the stem and configured to displace the stem in movement relative to the axis thereof to move the valve member between the open and closed positions; and
wherein the valve body further includes a packing chamber adjacent the passageway and receiving the stem passing therethrough, wherein the packing chamber is configured to receive a sealing body to fluidically seal the passageway at an interface with the stem;
the sealing device comprising:
   a tubular body forming the sealing body and extending along an axis from a first end to a second end, wherein the tubular body is configured for insertion into the packing chamber;
   wherein the tubular body is made from a composite polymeric material which is wearable and substantially resistant to deformation under mechanical pressure;
   a passageway in the tubular body and extending along the axis thereof, wherein the passageway opens at the first and second ends of the tubular body and is configured to substantially matably receive the stem therethrough, wherein the passageway comprises a first end portion at the first end of the tubular body, a second end portion at the second end of the tubular body and an intermediate portion therebetween, wherein the intermediate portion is generally cylindrical and the first end portion has reduced diameter relative thereto, wherein a diameter of the intermediate portion is sized larger than the diameter of the stem to form a circumferential gap between the intermediate portion of the passageway and the stem, wherein a prescribed diameter of the first end portion is sized smaller than the diameter of the stem such that the first end portion forms a seal around the stem by friction fit to resist passage of the fluid;
   an annular recess in the first end of the tubular body between the opening of the passageway and an outer surface of the tubular body arranged to face walls of the packing chamber, wherein the annular recess has a base spaced from the first end of the tubular body in an axial direction of the tubular body and opposite sidewalls interconnecting the base and the first end and which are spaced apart in a diametric direction of the tubular body;
   a biasing device configured to be located in the annular recess in the first end, wherein the biasing device has opposite sides configured to be urged apart when the biasing device is in a biased condition; and
   wherein, in the annular recess in the first end, the biasing device is arranged in the biased condition with the opposite sides thereof arranged to engage the sidewalls of said annular recess to exert force thereon directed radially of the tubular body, whereby the first end portion of the passageway is urged radially inwardly to exert pressure on the stem to enhance the seal therearound to resist leakage of the fluid from the valve passageway and into the passageway of the tubular body.

This provides an arrangement for sealing the valve stem against flow of fluid through the valve body in a manner which self-increases sealing pressure as an inner surface of the passageway, particularly at the first end portion, wears during movement of the stem.

In one arrangement, the composite polymeric material comprises polytetrafluoroethylene substantially reinforced with a stabilizing agent adapted to resist mechanical deformation of the polytetrafluoroethylene.

For example, the stabilizing agent comprises one or more of carbon and resin in fibrous form.

In one arrangement, the prescribed diameter of the first end portion is smaller than the prescribed diameter of the second end portion.

In one arrangement, the first end portion is tapered from the diameter of the intermediate portion to the prescribed diameter thereof.

In one arrangement, an end portion of the outer surface of the tubular body at the first end is flared outwardly to seal with the packing chamber by friction fit.

According to another aspect of the invention there is provided a method of forming a seal around a stem of a valve, the method comprising:
providing a tubular body with a passageway made of a wearable composite polymeric material, wherein the passageway is sized to substantially matably receive the stem and wherein at least one end portion of the passageway is sized smaller in diameter than the stem;
providing a biasing device arranged to apply a radially inward circumferential pressure in an annular recess in an end of the tubular body corresponding to the end portion with smaller diameter than the stem; and
forcibly passing the stem through the passageway to (i) stretchaby deform a peripheral wall of the passageway such that at least a portion of said end portion of the passageway substantially conform to the stem thereby forming a seal with the stem and (ii) to compress a radially intervening portion of the tubular body between the passageway and the annular recess, thereby compressibly loading the biasing device, so that it reacts to urge the intervening portion of the tubular body against the stem to enhance sealing at the corresponding end of the body.

These and other aspects are contemplated and described herein. It will be appreciated that the foregoing summary sets out representative aspects of sealing devices for valves to assist skilled readers in understanding the following detailed description.

### BRIEF DESCRIPTION OF THE DRAWINGS

The features of the invention will become more apparent in the following detailed description in which reference is made to the appended drawings wherein:

FIG. 1 is a sectional view of a valve with an arrangement of sealing device according to the present invention, showing a valve member of the valve in an open position;

FIG. 2 is a sectional of the valve of FIG. 1 showing the valve member in a closed position;

FIG. 3 is a perspective view of the arrangement of sealing device of FIG. 1;

FIG. 4 is an end view of the arrangement of sealing device of FIG. 1;

FIG. 5 is a cross-sectional view along line 5-5 in FIG. 4; and

FIG. 6 is an enlarged partial view of the valve of FIG. 1 in which an actuator of the valve and a valve body, and components internal thereto besides the valve member, are omitted for clarity of illustration.

### DETAILED DESCRIPTION

Embodiments will now be described with reference to the figures. For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative”or “exemplifying”and not necessarily as “preferred”over other embodiments. Further definitions for terms may be set out herein; these may apply to prior and subsequent instances of those terms, as will be understood from a reading of the present description.

In the accompanying figures there is shown a sealing device 100 for a valve 10. The valve 10 is configured to regulate or control flow of a fluid, typically a liquid, along a fluid-conveying line, such as a pipeline, guiding the fluid from a first location, such as a supply, to a second location in spaced relation to the first location, such as a target or destination. Thus, the valve 10 may be referred in industry as a control valve. Also, it will be appreciated that the fluid-conveying line may be considered as being formed, at least partially, by a first fluidic conduit 1 (schematically shown) receiving the fluid flowing from the first location; a second fluidic conduit 3 (schematically shown) guiding the fluid towards the second location; and the valve 10 acting to fluidically interconnect the fluidic conduits 1, 3. The sealing device 100 is configured to resist leakage of the fluid being conveyed along the line (the flow of which is to be regulated or controlled) from a valve body 12 which is configured to fluidically interconnect the first fluidic conduit 1 and the second fluidic conduit 3, and past a valve stem 14 which supports a valve member 16 for movement within the valve body 12 to either obstruct or permit flow of the fluid between ports 18A, 18B of the valve body at which the fluid-conveying conduits 1, 3 are fluidically connected to the valve body.

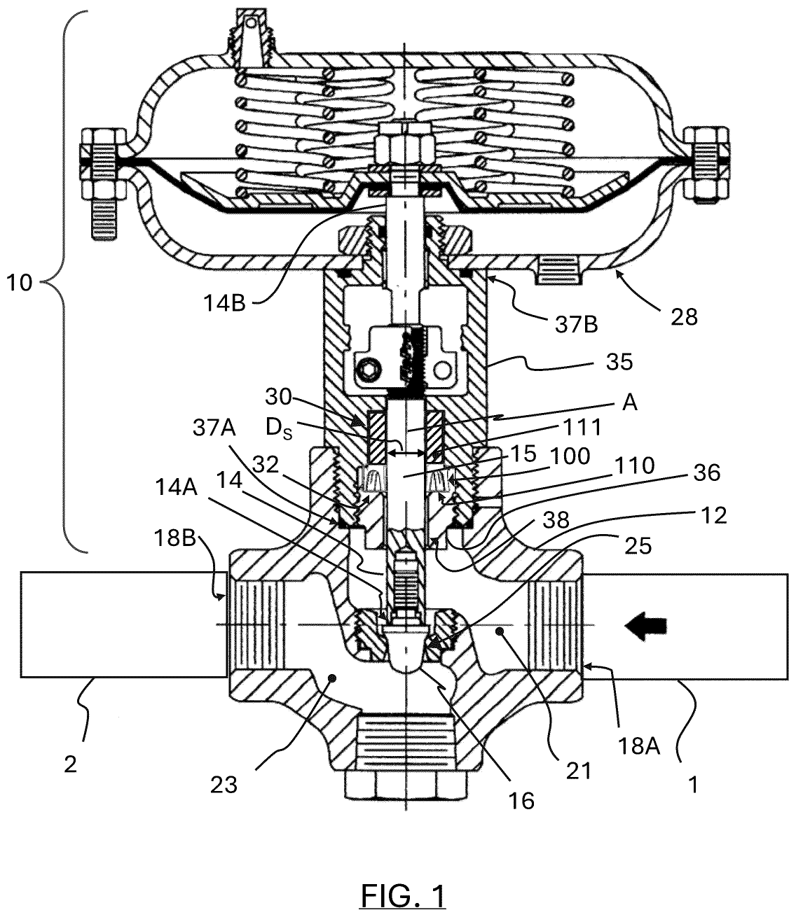

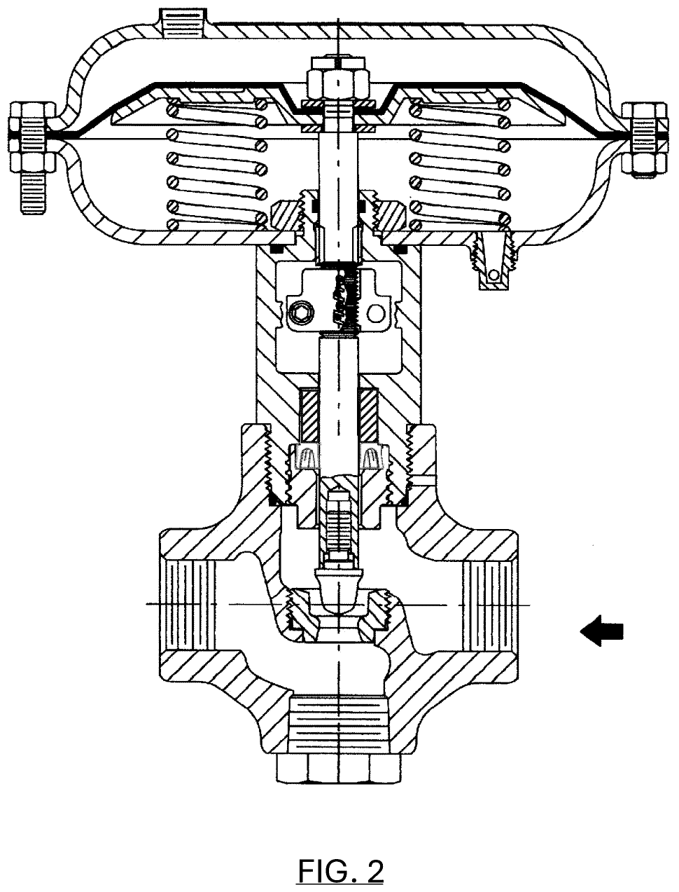

Turning initially to the valve 10, and with reference to FIGS. 1 and 2, the valve body 12 includes an inlet one of the ports, in this case indicated at 18A, which is configured for fluidic communication with the first fluidic conduit 1, as to receive the fluid therefrom, and an outlet one of the ports, in this case indicated at 18B, configured for fluidic communication with the second fluidic conduit 3 as to release the fluid thereto. Further, the valve body 12 includes a first chamber 21 in fluidic communication with the inlet port 18A, a second chamber 23 in fluidic communication with the outlet port 18B, and a valve seat 25 intercommunicating the first and second chambers 21, 23 to form a passageway for the fluid to flow from the inlet port to the outlet port. That is, the valve seat 25 acts as an internal passageway within the valve body to intercommunicate the first and second chambers.

In order to control the fluid flowing through the valve body, the valve 10 includes the valve member 16 supported inside the valve body 12 at or adjacent the valve seat 25 and arranged to selectively obstruct fluidic intercommunication between the first and second chambers 21, 23. The valve member 16 is movable relative to the valve seat 25 between an open position in which the fluid is permitted to flow from the first chamber 21 to the second chamber 23, as shown in FIG. 2, and a closed position in which the fluid is resisted from flowing from the first chamber to the second chamber, as shown in FIG. 1.

The stem 14 is connected to the valve member 16 and extends therefrom along an axis A of the stem. Further, the stem 14 is substantially cylindrical and has an outer surface 15 having a diameter D_{S} transverse or crosswise to the axis A.

To move the valve member, the valve 10 includes an actuator 28 operatively connected to the stem 14 and configured to displace the stem in movement relative to the axis thereof A to move the valve member 16 between the open and closed positions.

The valve body 12 further includes a packing chamber 30 adjacent the fluidic passageway of the valve and receiving the stem 14, which passes through the fluidic passageway. The packing chamber 30 acts to receive a sealing body to fluidically seal the fluidic passageway at an interface with the stem 14. Generally speaking, the packing chamber 30 includes a peripheral ledge 32 at or adjacent a proximal end thereof relative to the fluidic passageway of the valve to retain the sealing body in the packing chamber. That is, the ledge 32 forms a surface for buttingly engaging a face of the sealing body at an end thereof arranged proximally to the valve's fluidic passageway, while the packing chamber 30 remains open to the valve's fluidic passageway.

In the illustrated arrangement of valve, the valve is in the form of a globe valve in which the stem 14 is movable relative to the valve body 12 in reciprocating linear movement along the stem axis A, though in other arrangements which are not illustrated, the valve may be of a different type in which the stem is movable in rotary movement about its axis A.

Referring further to the illustrated arrangement in which the stem undergoes reciprocal linear movement between the open and closed positions, the valve member 16 is movable relative to the valve seat 25, as to obstruct or permit flow of the fluid therethrough, by displacement relative thereto. That is, in the open position, the valve member 16 is in spaced relation to the valve seat 25 as to provide a gap between the valve member and the valve seat to permit the fluid in the first chamber 21 to bypass the valve member, which gap is preferably around a full periphery thereof encompassing the stem axis A. In the closed position, the valve member 16 is substantially registered with the valve seat 25 such that there is no gap for the fluid to flow between the valve member and valve seat. As such, the valve member 16 is in the form of a plug which is configured for mating engagement with the valve seat in the closed position. More specifically, the plug is sized and shaped for mating engagement with a peripheral wall of the valve seat in the closed position of the valve member. Furthermore, the plug is supported at an end 14A of the stem that is proximal to the valve seat and thus located in the passageway of the valve body.

Further, it will be appreciated that in the illustrated globe valve, the stem 14 passes through the first chamber 21 as to locate the valve member 16 proximal to the valve seat for movement between the open and closed positions. Also, in the illustrated arrangement, the packing chamber 30 is formed by a separate housing 35 from the valve body 16, which is tubular as to permit passage of the stem 14, connected at a distal end 14B to the actuator, through opposite open ends 37A, 37B of the housing component 35 and into the valve body 12 where the proximal stem end 14A is located. Such a component 35 may be referred to in industry as a bonnet. The stem housing component or bonnet 35 forms the packing chamber 30 at a proximal one of its ends, which is in proximal relation to the valve body 12, in this case that indicated at 37A, which connects to the valve body 12, in this case by threadable mating. The packing chamber is enlarged in a transverse direction relative the stem as to provide a space for receiving the sealing body.

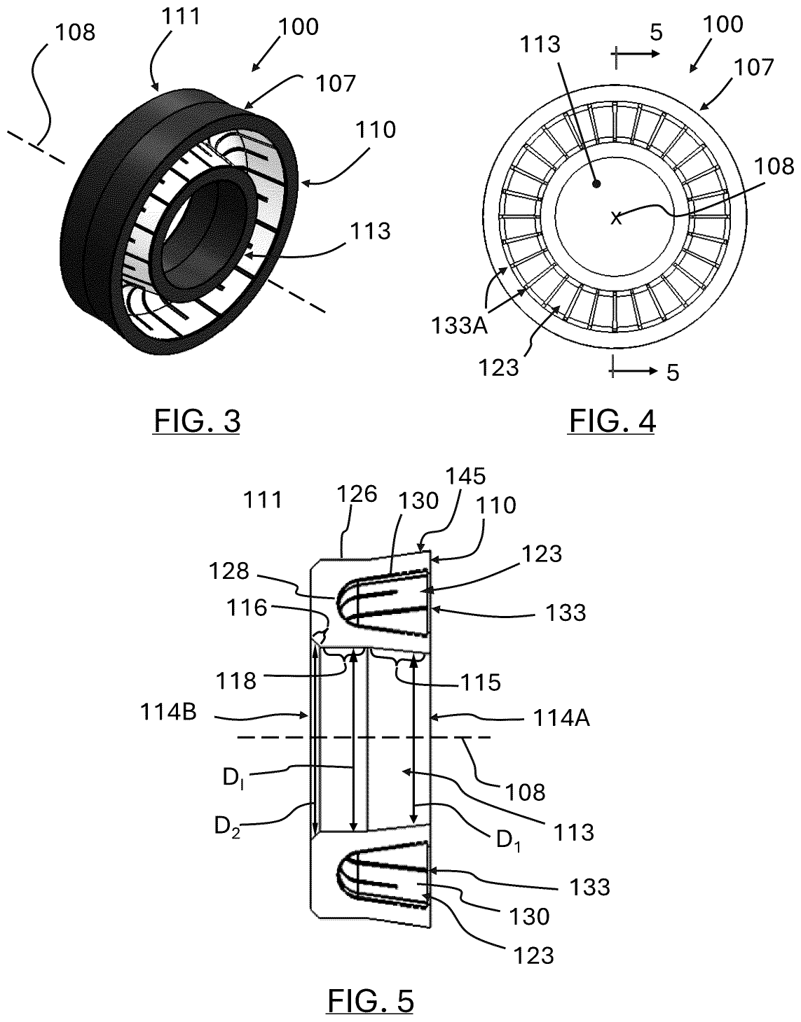

Turning now to the sealing device 100, and with reference to FIGS. 3-7, the sealing device comprises a tubular body 107 forming the sealing body and extending along an axis 108 from a first end 110 to a second end 111. The tubular body 107 is configured for insertion into the packing chamber 30. That is, the tubular body is sized and shaped to be received in the packing chamber. The packing chamber 30 is generally cylindrical, specifically circular cylindrical, and open at one end 37A thereof proximal to the transfer chamber to form an access opening for matable insertion of the tubular body of the sealing device. Since the packing chamber is substantially cylindrical in shape, the axially opposite ends 110, 111 of the body 107 are substantially planar, and at least the first end 110 is so, to substantially butt against a partial end wall or ledge 32 of the packing chamber proximal to the valve fluidic passageway. In the illustrated arrangement of valve, the ledge 32 is formed by a nut 36 threadably mated with the stem housing 35 at the proximal end thereof, such that the nut 36 is removable, that is, it is separable from the housing 35, to provide a suitable access opening for inserting the sealing body into the packing chamber 30 from the proximal end 37A of the housing component. The nuts 36 includes a bore 38 to permit passage of the stem 14 therethrough, by which the packing chamber 30 remains open to, as to be in fluidic communication with, the fluid passageway of the valve.

The tubular body 107 is a unitary body of a homogenous material, specifically a composite polymeric material which is wearable and substantially resistant to deformation under mechanical pressure. That is, the composite polymeric material is substantially rigid with a prescribed hardness permitting wear by physical contact therewith, for example rubbing due to sliding contact. The material may also be worn by force-fitting into a premanufactured opening formed therein an element sized slightly larger than the opening. The composite polymeric material is substantially resistant to deformation under mechanical pressure in that the material retains its predetermined or manufactured shape even under consistent yet large force. Consequently, when force fitted to correspond to a volume not corresponding to an external shape of the body or an internal passageway through the body, the composite polymeric material may act to temporarily conform to a surface of the force-fit object with which it is frictionally engaged.

In the illustrated arrangement, the composite polymeric material comprises polytetrafluoroethylene substantially reinforced with a stabilizing agent adapted to resist mechanical deformation of the polytetrafluoroethylene. In other words, the stabilizing agent acts to enhance durability of the polytetrafluoroethylene. Further, it will be appreciated that the stabilizing agent may comprise plural stabilizing agents. For example, the polytetrafluoroethylene is substantially reinforced carbon, and further with resin in fibrous form. In one arrangement, the polytetrafluoroethylene may be substantially reinforced with carbon as well as with fibrous resin such that there may be other additive materials in the composite polymer material but these are in minority ratios to the polytetrafluoroethylene than a ratio of the carbon or the resin thereto. Generally speaking, the composite polymeric material is primarily polytetrafluoroethylene, meaning a majority portion of the material is polytetrafluoroethylene, and minority portions thereof are respective stabilizing agents, such as carbon and fibrous resin. Polytetrafluoroethylene is commonly known as Teflon™.

Also, since the tubular body 107 of the illustrated arrangement, which is particularly suited for use in a control valve, may be exposed to the conveyed fluid, the composite polymeric material is adapted to be chemically nonreactive with a plurality of different types of fluid which may be conveyed. For example, in application in the oil/gas industry, constituent materials of the composite polymeric material are selected to be chemically reactive to the most common chemicals used in this application.

The sealing device 100 comprises a passageway 113 in the tubular body 107 and extending along the axis 108 thereof. The passageway 113 opens at 114A, 114B at the first and second ends 110, 111 of the tubular body and is configured to receive the stem 14 therethrough. More specifically, the passageway is configured to substantially matably receive the stem, that is it is sized and shaped to substantially match the size and shape of the stem, so as to enhance sealing therebetween, as will be better appreciated later.

As more clearly shown in FIG. 5, the passageway 113 comprises a first end portion 115 at the first end 110 of the tubular body and defining the first opening 114A; a second end portion 116 at the second end 111 of the tubular body and defining the second opening 114B; and an intermediate portion 118 between the first and second end portions. The intermediate portion 118 is generally cylindrical, that is, the intermediate portion has substantially constant diameter and cross-sectional shape, and at least the first end portion 115 has reduced diameter relative to the intermediate portion. (In other arrangements, the second end portion 116 may have reduced diameter relative to the intermediate portion, too.) Typically, as in the illustrated arrangement, the passageway has uniform cross-sectional shape along its full length between the opposite ends 110, 111 of the body 107 but different sizes at the various portions.

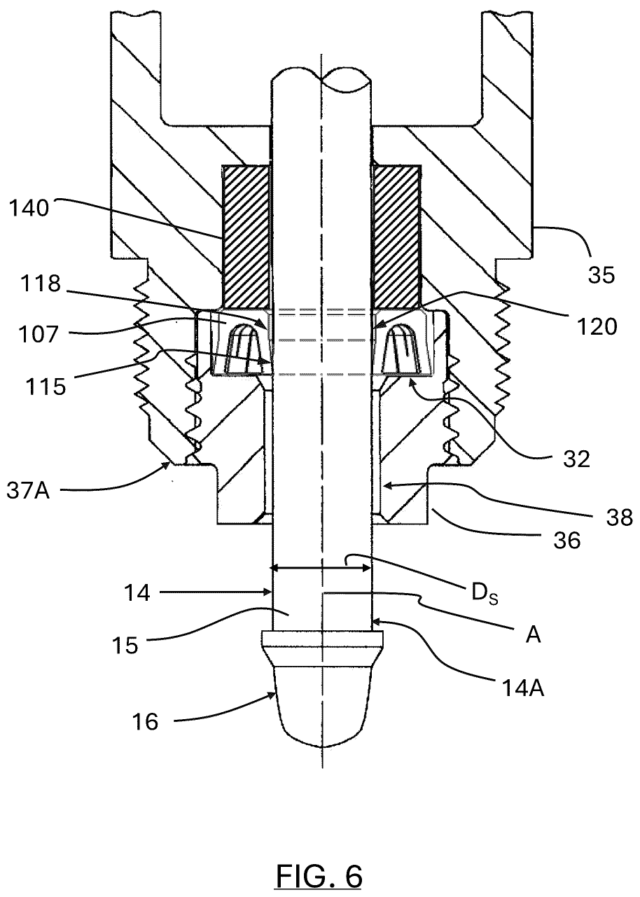

With reference to FIGS. 5 and 6, a diameter D_{I} of the intermediate portion 118 is sized larger than the diameter D_{S} of the stem to form a circumferential gap 120 between the intermediate portion of the passageway and the stem (FIG. 6). In this manner, there is substantially no contact between the body 107 and the stem at the intermediate portion.

However, a prescribed diameter D₁ of the first end portion 115 is sized smaller than the diameter D_{S} of the stem such that the first end portion forms a seal around the stem by friction fit to resist passage of the fluid. More specifically, insertion of the stem through the passageway causes wearing of the first end portion to substantially match the cross-section of the stem to provide a relatively tight fit between this interface of the passageway and the stem.

Furthermore, in the illustrated arrangement, the prescribed diameter D₁ of the first end portion is smaller than a prescribed diameter D₂ of the second end portion, which in the illustrated arrangement is larger than the prescribed diameter D_{I} of the intermediate portion.

The device 100 further comprises at least one annular recess 123 in at least one of the ends, in this case in at least the first end 110, of the tubular body between the corresponding opening of the passageway at that end, in this case 114A, and an outer surface 126 of the tubular body arranged to face an interior surface of the packing chamber 30. The annular recess 123 has a base 128 spaced from a corresponding one of the first and second ends 110, 111 of the tubular body in an axial direction of the tubular body and opposite sidewalls 130 interconnecting the base 128 and the corresponding one of the first and second ends 110, 111 and which are spaced apart in a diametric direction of the tubular body. That is, the annular recess is an endless circumferentially-extending groove in otherwise substantially planar ends of the tubular body 107.

In association with the annular recess 123, there is provided a biasing device 133 of the device 100 configured to be located in the annular recess in the first end 110. The biasing device has opposite sides 135 configured to be urged apart when the biasing device is in a biased condition. For example, the biasing device is a finger spring arranged to form a closed loop, for example by a series of individual finger springs 133A arranged in spaced relation in a loop-shaped path within the recess 123.

When placed in the annular recess 123 in the first end 110 of the body, the biasing device 133 is arranged in the biased condition with the opposite sides 135 thereof arranged to engage the sidewalls 130 of the annular recess 123 to exert force thereon directed radially of the tubular body 107, whereby the first end portion 115 of the passageway is urged or biased radially inwardly to exert pressure on the stem 12 to enhance the seal therearound for resisting leakage of the fluid from the transfer chamber 34 and into the passageway 113 of the tubular body. In other words, the force exerted by the biasing device on the sidewalls 130 of the recess 123 acts to induce internal stress within the body 107, which is directed in opposite radial directions from the recess or groove 123. This causes the first end portion to be biased radially inwardly towards the stem, enhancing the seal.

The recess 123 is disposed radially centrally between the passageway 113 and the outer surface 126 of the body, such that a distance from an inner one of the sidewalls of the recess, proximal to the passageway opening 114A, and a distance from an outer one of the sidewalls of the recess, proximal to the outer surface, are substantially equal.

In the illustrated arrangement, the first end portion 115 is tapered from the diameter D_{I} of the intermediate portion 118 to the prescribed diameters D₁ thereof. As such, the passageway is generally frustoconical in shape at the first end portion, but also is such at the second end portion which diverges from the intermediate portion so as to have a larger diameter than that of the intermediate portion.

Since the first end portion 115 is tapered, the inner sidewall of the recesses is inclined relative to the axis 108 so as to be generally parallel to the first end portion 115, so as to provide a substantially uniform thickness of constituent material of the body therebetween in the radial direction, through which pressure is applied from the biasing device 133.

In the illustrated arrangement, the first end portion 115 is tapered over a larger axial distance than the second end portion 116 varies in diameter. As such, the first end portion is longer along the axis 108 of the tubular body 107 than the second end portion 116. Thus, there is a larger surface area for sealing against the stem at the first end portion as it is primarily desirable to resist admittance of the conveyed fluid into the passageway.

To maintain the sealing device 100 in fixed relation in the packing chamber 30 against reciprocating movement of the stem 12, an end portion 145 of the outer surface 126 of the tubular body at the first end 110 is flared outwardly to an outer diameter sized larger than a diameter of the packing chamber which is substantially cylindrical, so as to seal with the packing chamber by friction fit. The biasing device 133 in the first annular recess 123 also acts to urge an outer portion of the body, disposed radially outwardly of the recess 123, against the packing chamber 30 to enhance engagement therein. Since the end portion 145 is tapered, the inner sidewall of the recesses is inclined relative to the axis 108 so as to be generally parallel to the first end portion 115, so as to provide a substantially uniform thickness of constituent material of the body therebetween in the radial direction. Therefore, flaring of the outer surface at this location on the body 107 acts to provide a substantially uniform thickness of material between the annular recess in the first end and the outer surface of the tubular body. As such, the tubular body 107 is wedged into the packing chamber 30 to be retained in fixed position and location therein.

This acts to leave a substantially uniform thickness of material between the annular recess 123 and the corresponding end portion 115 of the passageway, through which pressure is applied from the biasing device 133 received in the annular recess.

In some arrangements (not shown), to further aid in maintaining the sealing device 102 in fixed relation in the packing chamber, particularly against reciprocating movement of the stem, the tubular body may include one or more annular recesses at axially spaced locations on the outer surface 126 of the tubular body and one or more sealing gaskets received therein and arranged for engaging the packing chamber.

It will be appreciated that if the tubular body is shorter in length between the first and second ends 110, 111 than an axial length of the packing chamber 30 between retaining ledge 32 and opposite end wall in distal relation to the valve's fluid passageway and spaced from the ledge along the stem axis A, a tubular spacing assembly 140 comprising one or more spacer rings or collars may be inserted into the packing chamber 30 coaxially of the stem and adjacent the second end 111 of the tubular body 107 as to fill a void in distal relation to the open end 37A of the packing chamber with a substantially rigid filler material that will assist in retaining the tubular body 107 in fixed position relative to the stem 14. Thus, the spacing assembly 140 acts to fill a space between the sealing device 100 and the end wall of the packing chamber in opposite relation thereto.

This provides an arrangement for sealing the valve stem against flow of fluid through the valve body in a manner which self-increases sealing pressure as an inner surface of the passageway, particularly at the first end portion, wears during movement of the stem.

There is also disclosed herein a method of forming a seal around a stem of a valve, which generally comprises:
providing a tubular body with a passageway made of a wearable composite polymeric material, wherein the passageway is sized to substantially matably receive the stem and wherein at least one end portion of the passageway is sized smaller in diameter than the stem;
providing a biasing device arranged to apply a radially inward circumferential pressure in an annular recess in an end of the tubular body corresponding to the end portion with smaller diameter than the stem; and
forcibly passing the stem through the passageway to (i) stretchaby deform a peripheral wall of the passageway such that at least a portion of said end portion of the passageway substantially conform to the stem thereby forming a seal with the stem and (ii) to compress a radially intervening portion of the tubular body between the passageway and the annular recess, thereby compressibly loading the biasing device, so that it reacts to urge the intervening portion of the tubular body against the stem to enhance sealing at the corresponding end of the body.

It will be appreciated that the deformation caused by passing the stem through the passageway is substantially not permanent such that the passageway may return to its original shape provided that the amount or degree of deformation is within acceptable tolerances as not to reduce sealing performance at the stem.

Furthermore, it will be appreciated that due to a degree of conformability of the composite polymeric material when under mechanical pressure causing deformation, as is the case of the stem frictionally fit through the internal passageway 113, a surface of the passageway 113 may conform to changes in the outer surface 15 of the stem, for example, scratches due to abrasion from solid debris in the fluid conveyed by the line and through the valve.

As described hereinbefore, the sealing device 100, which may be referred as a cartridge, is inserted into a valve and replaces a stacked series of chevron style V-rings which are adjustable for providing different amounts or degrees of sealing pressure through variation of compression of the matably stacked V-rings.

Teflon™ is a base material that has excellent chemical compatibility however unlike elastomers Teflon has the undesirable characteristic of cold flowing which is changing shape under pressure and not returning to its original form. The non-adjustable cartridge is made from a highly modified form of Teflon™ with reinforcing stabilizing agents such as carbon and resin in a fibrous form, which reduces cold flowing. The illustrated arrangement of cartridge above uses a stainless-steel laser cut finger spring to provide exaggerated seal on the high pressure side of the cartridge which is disposed at the valve's fluidic passageway, therefore a single sealing area such as that provided by the first end portion may be used in place of multiple stacked chevron style rings. The spring-loaded mechanical aspect ensures the modified Teflon does not have a chance to cold flow or change shape and the modified Teflon is chemically compatible with a plurality of different types of chemicals used within the oil and gas production industry. The need for the development of this technology is exacerbated by new compositions introduced to the oil and gas production industry, these chemicals are highly effective in reducing corrosion inside pipelines and pressure vessels but they are very difficult to reliably contain. They are flammable and toxic with a wide range of chemical constituents that are chemically incompatible with most elastomers and these chemicals show an affinity for metal surfaces, that is the chemicals often stick or adhere to metal surfaces of the valve and fluid conveying line when made of metal. This sticking characteristic may be alleviated by a wiper ring on the low pressure of the sealing device opposite the spring end. The wiper ring is made to scrape the chemical off the critical components of the fluid end which will reduce the damaging effect of the adhered chemical for chemical injection components.

In other words, the sealing device, which may be informally referred to as a packing, acts a replacement for chevron style packing rings made from elastomeric material. The body of the packing, which is exposed to the chemical being transferred through the fluid conveying line, is made from Polytetrafluoroethylene substantially reinforced with carbon and other stabilizing constituents. Thus, the body is substantially rigid so as not to be flexible. The body includes a passageway through which a stem of the valve passes in coaxial relation to the passageway. A first end portion of the body, which is arranged to be exposed to fluid flowing through the fluid conveying line, and under a relatively high pressure, receives in a recess in an end face of said end portion a device which applies radial pressure (relative to the axis of the body) on walls of the recess to urge a peripheral wall of the passageway towards the stem thereby enhancing sealing action of the body on the stem. The low-pressure side of the packing at an opposite end thereof faces out of the fluid end. When optionally used with a secondary containment system as described in further detail herein, the low-pressure end of the cartridge is fluidically sealed with a packing nut part of the secondary containment.

Thus, there is a single seal in front of a solid mass. The body seats with a spring-loaded seal exposed to the process pressure, in a recess formed therein, a spring-loaded seal which fluidically seal the body with the stem of the valve.

As described hereinbefore, the present invention relates to a sealing device for a valve, which is configured to be received in a packing chamber of the valve and to matably receive a stem of the valve therethrough that moves a valve member for selectively permitting flow of fluid through the valve body between a pair of ports thereof. The sealing device features a tubular body made of wearable and substantially deformation-resistant composite polymer material and a passageway which is shaped with opposite end portions of reduced diameter to form a sealing friction fit with the stem.

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

1. A sealing device for a valve, wherein the valve has:
a valve body configured to fluidically interconnect a first fluidic conduit for conveying a fluid and a second fluidic conduit for selectively receiving the fluid, wherein the valve body includes an inlet port configured for fluidic communication with the first fluidic conduit and an outlet port configured for fluidic communication with the second fluidic conduit;
wherein the valve body further includes a first chamber in fluidic communication with the inlet port, a second chamber in fluidic communication with the outlet port, and a valve seat intercommunicating the first and second chambers to form a passageway for the fluid to flow from the inlet port to the outlet port;
a valve member supported inside the valve body at or adjacent the valve seat and arranged to selectively obstruct fluidic intercommunication between the first and second chambers, wherein the valve member is movable relative to the valve seat between an open position in which the fluid is permitted to flow from the first chamber to the second chamber and a closed position in which the fluid is resisted from flowing from the first chamber to the second chamber;
a stem connected to the valve member and extending therefrom along an axis, wherein the stem is substantially cylindrical and has an outer surface having a diameter transverse to the axis;
an actuator operatively connected to the stem and configured to displace the stem in movement relative to the axis thereof to move the valve member between the open and closed positions; and
wherein the valve body further includes a packing chamber adjacent the passageway and receiving the stem passing therethrough, wherein the packing chamber is configured to receive a sealing body to fluidically seal the passageway at an interface with the stem;
the sealing device comprising:
a tubular body forming the sealing body and extending along an axis from a first end to a second end, wherein the tubular body is configured for insertion into the packing chamber;
wherein the tubular body is made from a composite polymeric material which is wearable and substantially resistant to deformation under mechanical pressure;
a passageway in the tubular body and extending along the axis thereof, wherein the passageway opens at the first and second ends of the tubular body and is configured to substantially matably receive the stem therethrough, wherein the passageway comprises a first end portion at the first end of the tubular body, a second end portion at the second end of the tubular body and an intermediate portion therebetween, wherein the intermediate portion is generally cylindrical and the first end portion has reduced diameter relative thereto, wherein a diameter of the intermediate portion is sized larger than the diameter of the stem to form a circumferential gap between the intermediate portion of the passageway and the stem, wherein a prescribed diameter of the first end portion is sized smaller than the diameter of the stem such that the first end portion forms a seal around the stem by friction fit to resist passage of the fluid;
an annular recess in the first end of the tubular body between the opening of the passageway and an outer surface of the tubular body arranged to face walls of the packing chamber, wherein the annular recess has a base spaced from the first end of the tubular body in an axial direction of the tubular body and opposite sidewalls interconnecting the base and the first end and which are spaced apart in a diametric direction of the tubular body;
a biasing device configured to be located in the annular recess in the first end, wherein the biasing device has opposite sides configured to be urged apart when the biasing device is in a biased condition; and
wherein, in the annular recess in the first end, the biasing device is arranged in the biased condition with the opposite sides thereof arranged to engage the sidewalls of said annular recess to exert force thereon directed radially of the tubular body, whereby the first end portion of the passageway is urged radially inwardly to exert pressure on the stem to enhance the seal therearound to resist leakage of the fluid from the valve passageway and into the passageway of the tubular body.

2. The sealing device of claim 1 wherein the composite polymeric material comprises polytetrafluoroethylene substantially reinforced with a stabilizing agent adapted to resist mechanical deformation of the polytetrafluoroethylene.

3. The sealing device of claim 1 wherein the prescribed diameter of the first end portion is smaller than the prescribed diameter of the second end portion.

4. The sealing device of claim 1 wherein the first end portion is tapered from the diameter of the intermediate portion to the prescribed diameter thereof.

5. The sealing device of claim 1 wherein an end portion of the outer surface of the tubular body at the first end is flared outwardly to seal with the packing chamber by friction fit.

6. A method of forming a seal around a stem of a valve, the method comprising:
providing a tubular body with a passageway made of a wearable composite polymeric material, wherein the passageway is sized to substantially matably receive the stem and wherein at least one end portion of the passageway is sized smaller in diameter than the stem;
providing a biasing device arranged to apply a radially inward circumferential pressure in an annular recess in an end of the tubular body corresponding to the end portion with smaller diameter than the stem; and
forcibly passing the stem through the passageway to (i) stretchaby deform a peripheral wall of the passageway such that at least a portion of said end portion of the passageway substantially conform to the stem thereby forming a seal with the stem and (ii) to compress a radially intervening portion of the tubular body between the passageway and the annular recess, thereby compressibly loading the biasing device, so that it reacts to urge the intervening portion of the tubular body against the stem to enhance sealing at the corresponding end of the body.
